(19) United States
(12) Patent Application Publication
(10) Pub. No.: US 2006/0201761 A1
(43) Pub. Date: Sep. 14, 2006

(54) Fluid Dynamic Bearing, Spindle Motor, and Recording Disk Driving Device

(75) Inventors: Takuro Iguchi, Kyoto (JP); Hiromitsu Takamatsu, Utsunomiya-shi, Tochigi (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: NIDEC CORPORATION, Kyoto (JP)

(21) Appl. No.: 11/276,730

(22) Filed: Mar. 13, 2006

(30) Foreign Application Priority Data
Mar. 11, 2005 (JP) 2005-068528
Mar. 9, 2006 (JP) 2006-064026

(51) Int. Cl. F16D 65/827; B60G 13/00

(52) U.S. Cl. 188/264 R; 267/217

(57) ABSTRACT

A radial gap is formed between an outer circumferential surface of a shaft and an inner circumferential surface of a sleeve. The outer circumferential surface of the shaft and the inner circumferential surface of the sleeve radially face each other. Within the radial gap, a radial dynamic bearing portion including a groove row of dynamic pressure generating grooves each of which are circumferentially arranged so as to form a herringbone shape is formed. At axially upper and bottom portions of the groove row, upper and bottom planar circumferential portions are formed respectively. Axial width of the upper planar circumferential portion is wider than axial width of the bottom planar circumferential portion.

### BACKGROUND OF THE INVENTION

1. Technical Field

The present invention generally relates to a low-profile fluid dynamic bearing, a low-profile spindle motor, and a low-profile recording disk driving device.

2. Background Art

Recently, information reading/writing devices such as hard disk driving devices are being installed not only in computers, but also in mobile devices. In order to install the hard disk driving devices into mobile devices, the hard disk driving devices have to be small and thin. In addition, the hard disk driving devices for mobile devices should have an improved anti-impact property so as to endure the impact caused by dropping the mobile devices. Consequently, there is a growing demand for small and thin hard disk driving devices, as well as spindle motors having high anti-impact property.

FIG. 9 is a longitudinal sectional view showing a conventional thin bearing mechanism. The conventional thin bearing mechanism includes a radial dynamic bearing portion. The shaded portion in FIG. 9 shows a planar circumferential portion formed between an inner circumferential surface of a sleeve 1 and an outer circumferential surface of a shaft 2.

As shown in FIG. 9, a radial dynamic bearing portion la is formed between the sleeve 1 and the shaft 2, both of which are in cylindrical shape. The radial dynamic bearing portion 1 a includes a plurality of dynamic pressure generating grooves 1b which are arranged in a circumferential direction so as to form a herringbone shape. The dynamic pressure generating grooves 1b are formed either on an inner circumferential surface of the sleeve 1 or on an outer circumferential surface of the shaft 2. The radial bearing portion la is filled with lubricant fluid. An outer circumferential portion of the sleeve 1 is fixed to a housing 3.

When the dynamic pressure generating grooves 1b are formed as reaching an axially upper end portion and an axially bottom end portion of the radial dynamic bearing portion, the pressure of the lubricant fluid may decrease. Then, the sleeve 1 and the shaft 2 may contact at the upper and bottom end portions of the radial dynamic bearing portion 1a when the shaft 2 is inclined by an external impact. As a result, the sleeve 1 may be worn out. When an internal space of the radial dynamic bearing portion 1a is contaminated with wear-out powder generated by wearing out of the sleeve 1, the sleeve 1 is worn out further and may generate sludge. The worn-out powder may further cause seizure of the sleeve 1 and the shaft 2, such that the shaft 2 does not rotate anymore.

### BRIEF SUMMARY OF THE INVENTION

A fluid dynamic bearing of a preferred embodiment according to the present invention includes a sleeve portion, a shaft which is inserted into the sleeve portion and is rotatable around a rotation axis relative to the sleeve portion, and a rotor which is fixed either to the sleeve portion or to the shaft and includes a disk placing portion arranged at an axially upper portion of the sleeve or the shaft to place a recording disk thereon.

A radial gap including lubricant fluid therein is formed between an inner circumferential surface of the sleeve portion and an outer circumferential surface of the shaft.

A radial dynamic bearing portion includes a groove row of the dynamic pressure generating grooves inducing dynamic pressure in the lubricant fluid during the rotation of the rotor. The radial dynamic bearing portion is formed either on the inner circumferential surface of the sleeve or on the outer circumferential surface of the shaft both of which coordinately forms the radial gap. Only one radial dynamic bearing portion is formed at the radial gap.

An upper planar circumferential portion is formed at a position which is upward of the upper end portion of the groove row and is either on the outer circumferential portion of the shaft or on the inner circumferential surface of the sleeve portion which compose the radial gap. The center of gravity of the rotor locates in an upward position from the portion at which the dynamic pressure of the lubricant fluid is maximized during the rotation of the rotor.

Therefore, a fluid dynamic bearing, a spindle motor, and a recording disk driving device, which are highly reliable and has an anti-impact property, may be provided.

In the description of the present invention, words such as upper, bottom, lower, left, and right for explaining positional relationships between respective members and directions merely indicate positional relationships and directions in the drawings. Such words do not indicate positional relationships and directions of the members mounted in an actual device.

### BRIEF DESCRIPTION OF THE SEVERAL VIEWS OF THE DRAWINGS

FIG. 1 is a longitudinal sectional view showing the first preferred embodiment of the present invention;

FIG. 2 is a longitudinal sectional view of a radial dynamic bearing portion described in FIG. 1;

FIG. 3 is a longitudinal sectional view showing the second preferred embodiment of the present invention;

FIG. 4 shows a thrust dynamic bearing portion described in FIG. 1;

FIG. 5 shows the third preferred embodiment of the present invention;

FIG. 6 is a longitudinal sectional view showing one preferred embodiment of a spindle motor according to the present invention;

FIG. 7 is a longitudinal sectional view showing one preferred embodiment of a recording disk drive device including the spindle motor described in FIG. 6;

FIG. 8 shows a fourth preferred embodiment of the present invention;

FIG. 9 is a longitudinal sectional view showing a conventional dynamic bearing portion; and

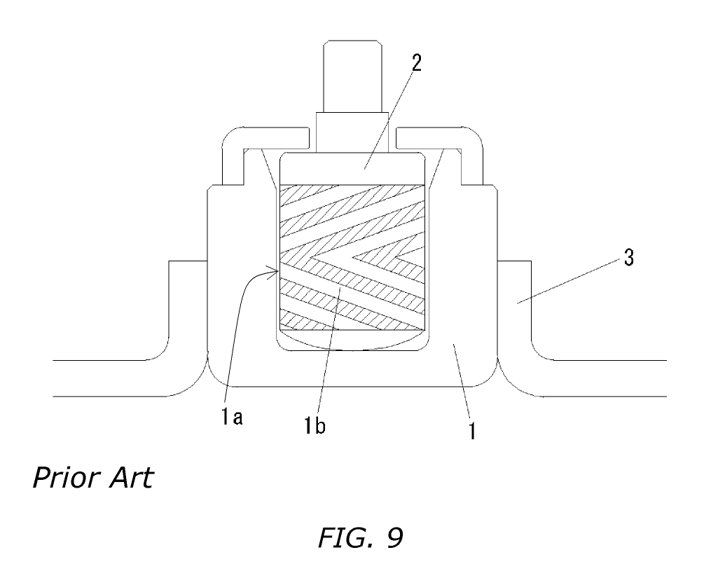

FIG. 10 shows the fifth preferred embodiment of the present invention.

### DETAILED DESCRIPTION OF THE INVENTION

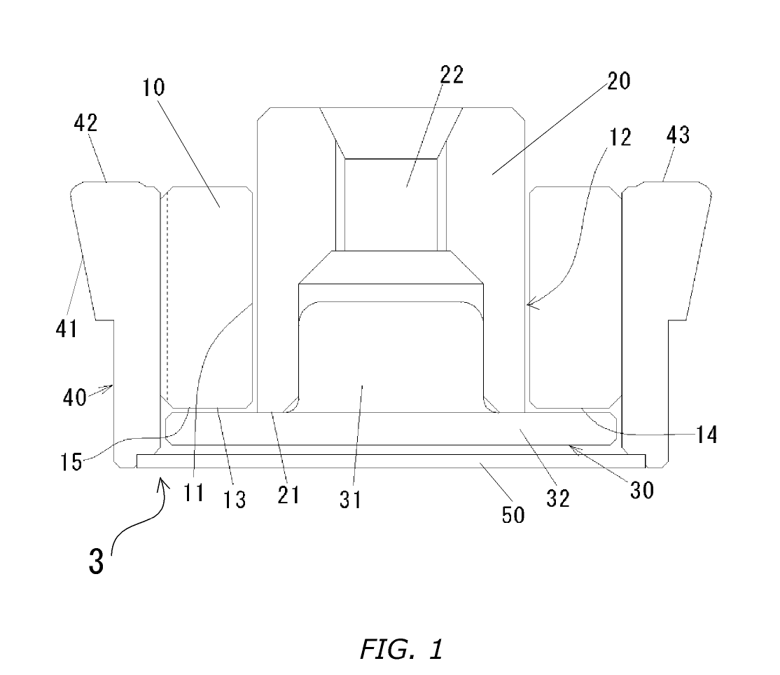

Preferred embodiments according to the present invention will be described by reference to FIGS. 1 through 8 and 10.

### FIRST PREFERRED EMBODIMENT

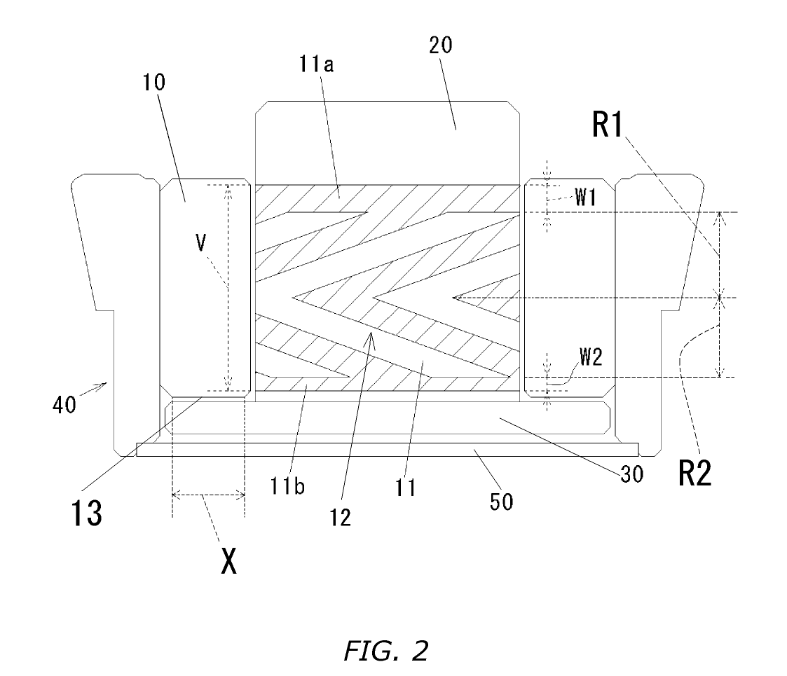

FIG. 1 shows a fluid dynamic bearing of one preferred embodiment according to the present invention. FIG. 2 is a longitudinal sectional view of the radial dynamic bearing portion described in FIG. 1. A shaded portion of FIG. 2 shows a planar circumferential portion of the herringbone shaped groove row.

A sleeve portion 3 includes a sleeve 10, a sleeve housing 40 supporting the sleeve 10, and a plate 50 occluding a bottom end of the sleeve housing 40. A sleeve 10 is a hollow cylindrical member receiving a shaft 20 therein. The shaft 20 radially faces an inner circumferential surface of the sleeve 10. A cap 30 is fixed to a bottom portion 21 of the shaft 20.

The cap 30 includes a convex portion 31 and a disk portion 32. The convex portion 31 is fixed at a hollow portion 22 of the shaft 20, and the disk portion 32 radially spreads from the convex portion 22. When a motor is driving, the disk portion 32 faces a bottom end surface 13 of the sleeve 10 with a gap maintained therebetween. An outer peripheral surface of the disk portion 32 faces an inner peripheral surface of the sleeve housing 40 with a gap maintained therebetween.

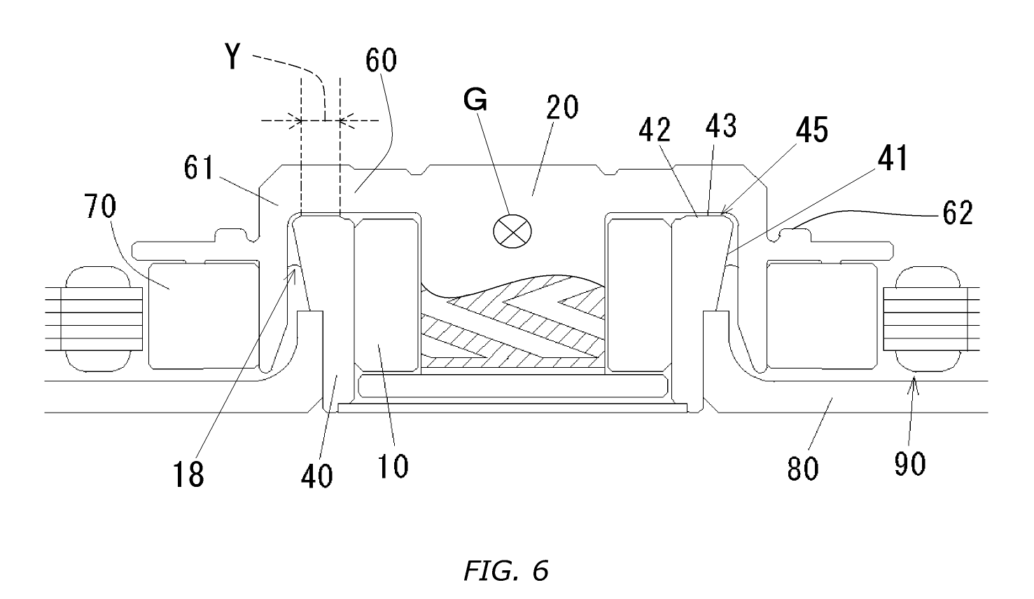

The sleeve housing 40 in a substantially cylindrical shape is fixed to an outer peripheral surface of the sleeve 10. An upper thrust dynamic bearing portion 45 is formed at a gap between the upper end surface 42 of the sleeve housing 40 and a bottom surface of a rotor hub 60 (see FIG. 6). A groove row 42 of dynamic pressure generating grooves is circumferentially arranged so as to form a herringbone shape (upper thrust dynamic pressure generating grooves) and is provided on the upper end surface 42 of the sleeve housing 40.

A bottom end portion of the sleeve housing 40 is occluded by a plate 50 which axially faces the disk portion 32 with a gap maintained therebetween.

A gap of a radial dynamic bearing portion 12, a gap of a bottom dynamic bearing portion 15, and a gap of an upper dynamic bearing portion 45 are formed in a continuous manner and are continuously filled with lubricant fluid such as oil.

As shown in FIG. 6, a sloping surface 41 is arranged at an upper portion of the outer circumferential surface of the sleeve housing 40. A diameter of the sloping surface 41 gradually decreases along with the axial direction downwardly from an upper end portion of the sloping surface. A gap between the sloping surface and an inner circumferential surface of a cylindrical portion 61 of a rotor hub 60 which radially faces the sloping surface becomes wider along with axial direction downwardly. Therefore, a taper seal portion 18 is formed by the sloping surface 41 and the cylindrical portion 61 of the rotor hub 60. The oil maintained within the gap aforementioned interfaces with air only at the taper seal portion 18 at which a surface tension of the oil is balanced with an outside pressure.

With reference to FIG. 2, a radial dynamic bearing portion 12 is described in detail.

The radial dynamic bearing portion 12 is formed at a gap between the inner circumferential surface of the sleeve 10 and the outer circumferential surface of the shaft 20. The radial dynamic bearing portion 12 includes one axial portion at which the dynamic pressure of the oil is maximized. Hereinafter, a radial gap V is defined as a gap between the outer circumferential surface of the shaft 20 and the inner circumferential surface of the sleeve 10. Either on the outer circumferential surface of the shaft 20 or on the inner circumferential surface of the sleeve 10, an upper planar circumferential portion and a bottom planar circumferential portion are provided.

The radial dynamic bearing portion 12 includes a groove row 11 of dynamic pressure generating grooves circumferentially arranged so as to form a herringbone shape. The groove row 11 induces the oil from both axially upper and axially bottom end portions of the radial dynamic bearing portion 12 into a substantially axially middle portion of the radial dynamic bearing portion 12. The groove row 11 is in axially asymmetric shape (R1>R2) and the dynamic pressure generating grooves of the groove row 11 are equally spaced in a circumferential direction. Each of the dynamic pressure generating groove is composed of a pair of spiral grooves, which axially neighbor each other and incline from the rotation axis.

When the shaft 20 rotates, the movement pressures are induced, downward pressure that moves oil from an upper portion into a middle portion of the bearing portion and upward pressure that is moves oil from a bottom portion into the middle portion of the bearing portion. With the downward and upward pressures, the oil is induced to around the middle portion of the radial dynamic bearing portion 12. However, with the groove row 11 formed in the asymmetric shape, the downward pressure becomes slightly greater than the upward pressure, such that the oil is induced to the slightly bottom portion from the middle portion of the radial dynamic bearing portion 12. As a result, the pressure of the oil becomes maximum at the slightly bottom portion mentioned above. The difference between the upward and the downward pressures generates a downward oil flow so as to prevent a negative pressure occurrence.

An upper planar circumferential portion 11a is formed at an upper portion of the groove row 11, and a bottom planar circumferential portion 11b is formed at a bottom portion of the groove row 11. An axial width W1 of the upper planar circumferential portion 11a is wider than an axial width W2 of the bottom planar circumferential portion 11b.

The upper planar circumferential portion 11a and the bottom planar circumferential portion 11b increase the pressure within the gap between the shaft 20 and the upper planar circumferential portion 11a, and the pressure within the gap between the shaft 20 and the bottom planar circumferential portion 11b. With the increased pressures mentioned above, the anti-slant property of the shaft of the motor is improved when the motor rotates.

If the rotor hub including the rotor magnet is fixed to the upper portion of the shaft 20, the center of gravity G of the rotor including the rotor hub and the rotor magnet will locates around the upper planar circumferential portion 11a (see FIG. 6). The axial width W1 of the upper planar circumferential portion 11a is formed wide so that the center of gravity G is less likely to drift when the radially moment is applied to the rotor hub. Therefore, the rotor is less likely to be influenced by the moment. In other words, the rotor is securely supported, and the fluid dynamic bearing which is highly reliable and shock resistant may be provided.

In the first preferred embodiments of the present invention, it is preferable to provide one groove row of dynamic pressure generating grooves because the axial width of the radial gap V is narrow, about 2.3 mm. In general, it is preferred that axial width of the groove row is greater than about 0.8 mm to securely support the shaft 20. When two groove rows are formed at the radial gap, the total axial width of the two groove rows will be about 1.6 mm. Since the available space is very limited, it is difficult to additionally provide the upper planar circumferential portion and the bottom planar circumferential portion of the present invention in an effective manner to the radial dynamic bearing portions including two groove rows. Therefore, only one groove row of dynamic pressure generating grooves is provided in the preferred embodiments of the present invention.

In the preferred embodiment of the present invention, the sleeve 10 is made of the porous sintered material which is impregnated with oil. The sleeve may be formed by molding and sintering various metal powders, metal compound powders, or non-metal powder. Preferred material according to the preferred embodiment includes, but not limited, Fe—Cu, Cu—Sn, Cu—Sn—Pb, Fe—C, and so on. The groove row formed in a herringbone shape, the upper planar circumferential portion, and the bottom planar circumferential portion may be formed all together when the sleeve 10 is molded, such that production cost of the sleeve 10 may be reduced.

The groove row in a herringbone shape, the upper planar circumferential portion, and the bottom planar circumferential portion may be formed on the outer circumferential surface of the shaft in stead of the inner circumferential surface of the sleeve. In addition, the groove row in the herringbone shape may be formed either on the sleeve or on the shaft, and the upper planar circumferential portion and the bottom planar circumferential portion may be provided on the other.

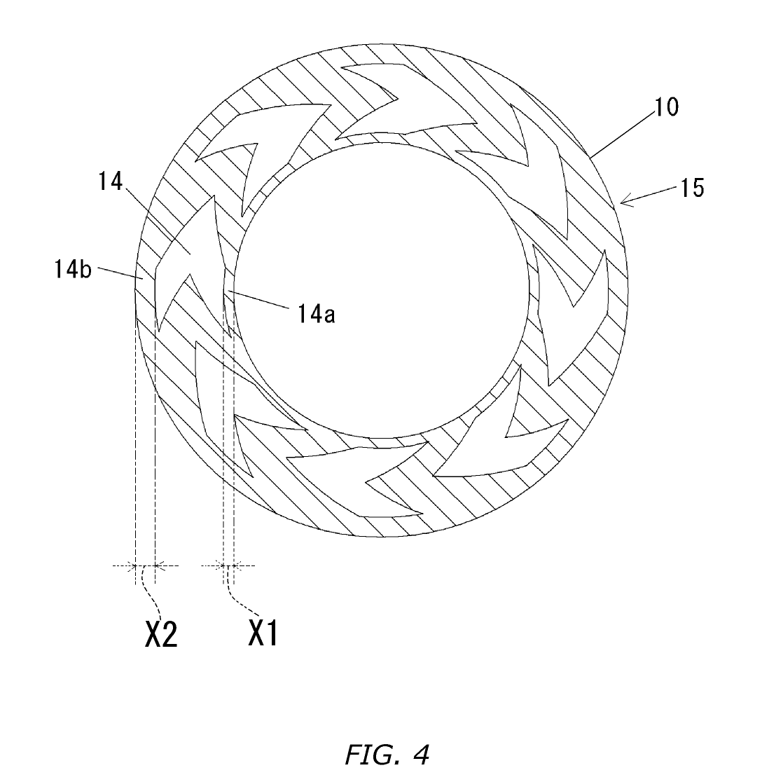

With reference to FIG. 4, the thrust dynamic bearing portion is described in detail.

A bottom thrust dynamic bearing portion 15 is provided at a gap between the bottom end surface 13 of the sleeve 10 and the upper end surface of the disk portion 32. As shown in FIG. 4, a groove row 14 of the dynamic pressure generating groove (the bottom thrust dynamic pressure generating grooves) circumferentially arranged so as to form a herringbone shape is formed on the bottom end surface 13 of the sleeve 10. Hereinafter, a bottom thrust gap X is defined as a gap between the disk portion 32 and the bottom end surface 13 of the sleeve 10 on which a bottom an inner planar circumferential portion 14a, an outer planar circumferential portion 14b, and thrust dynamic bearing portion 15 are formed.

On the bottom end surface 13 of the sleeve 10, the inner planar circumferential portion 14a and the outer planar circumferential portion 14b are formed at a radially inner and outer portion of the groove row 14 respectively. Radial width X1 of the inner planar circumferential portion 14a is narrower than radial width X2 of the outer planar circumferential portion 14a.

In general, the rotor slants when the strong external force is applied to the rotor during its rotation. As a result, the outer circumferential portion of the disk portion 32 and the bottom end surface 13 of the sleeve 10 come close each other. However, with the outer planar circumferential portion 14b, pressure within the gap between the outer planar circumferential portion 14b and the outer circumferential surface of the disk portion 32 increases, such that the anti-slant property of the motor is improved during the rotation.

With the radial gap V and the thrust gap X including aforementioned planar circumferential portions respectively, the anti-slant property is improved further. Therefore, a fluid dynamic bearing which is highly reliable and shock-resistant may be provided.

The outer planar circumferential portion and the inner planar circumferential portion may be formed at the upper thrust dynamic bearing portion 45. The rotor may be further securely supported by the upper thrust dynamic bearing portion 45 including the outer planar circumferential portion and the inner planar circumferential portion cooperating with the radial dynamic bearing portion mentioned above.

With reference to FIG. 6, a spindle motor including the fluid dynamic bearing according to the present invention is described in detail.

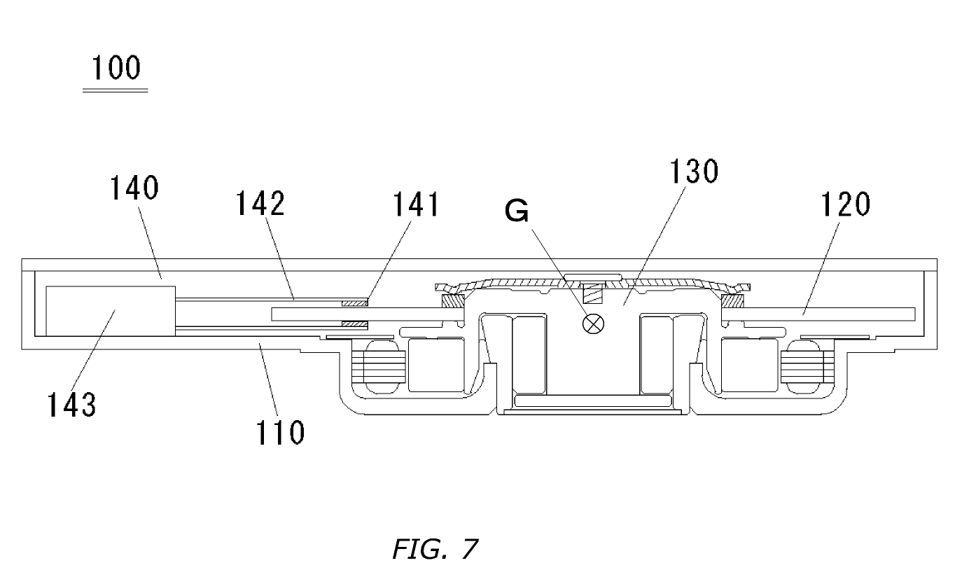

A rotor hub 60 in a substantially cupped shape is formed at the upper portion of the shaft 20 and supports a recording disk 170 (see FIG. 7). The rotor hub 60 may be integrally formed with the shaft 20. Alternatively, the rotor hub 60 may be formed into a separate piece of a member from the shaft 20. At the outer circumferential portion of the rotor hub 60, a cylindrical portion 61 downwardly suspending is formed. The recording disk 170 is supported at an outer circumferential portion of the cylindrical portion 61, and the rotor magnet 70 is supported at the bottom portion of the outer circumferential portion of the cylindrical portion 61. A disk placing portion 62 is formed at a radially outward portion of the cylindrical portion 61. On the disk placing portion 62, a recording disk (see 120 of FIG. 7) is placed.

The sleeve housing 40 is fixed to a base 80. A stator 90 is fixed to the base 80, and the stator 90 radially faces the outer circumferential surface of the rotor magnet 70 with a gap maintained therebetween. When the electric power is provided to winding wires of the stator 90, magnetic field is generated. The magnetic interaction between the magnetic field and the rotor magnet generates torque and rotates the rotor.

With reference to FIG. 7, a recording disk driving device 100 according to the present invention is described in detail.

The recording disk driving device 100 includes a housing 110 in a rectangular shape. The inside space of the housing 100 is provided as an extremely clean space including only a few dust particles. A spindle motor 130 with a hard disk 120 storing information is arranged within the housing 110.

A head mechanism 140 which read/write information from/on the hard disk 120 is arranged within the housing 110. The head mechanism 140 includes a magnetic head 141 reading/writing information from/on the hard disk 120, an arm 142 supporting the magnetic head 141, and an actuator 143 displacing the magnetic head 141 and the arm 142 into the specific location over the hard disk 120.

By adopting the spindle motor according to the present invention, the recording disk driving device 100 may become smaller and thinner with maintaining sufficient properties. Moreover, the recording disk driving device which are highly reliable and shock-resistant may be provided.

### SECOND PREFERRED EMBODIMENT

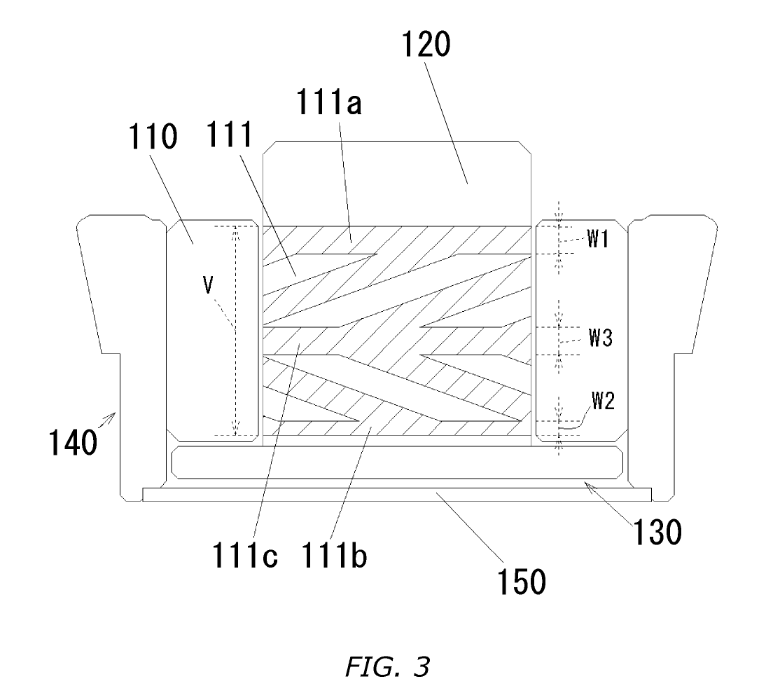

With reference to FIG. 3, a second preferred embodiment according to the present invention is described in detail.

As shown in FIG. 3, a radially middle planar circumferential portion 111c is formed at a substantially middle portion of a radial dynamic bearing portion 111. An axial width W3 of the middle planar circumferential portion 111c is wider than the axial width W2 of a bottom planar circumferential portion 111b. The radial middle planar circumferential portion 111c cooperates with an upper planar circumferential portion 111a and the bottom planar circumferential portion 111b so as to securely support the rotor.

### THIRD PREFERRED EMBODIMENT

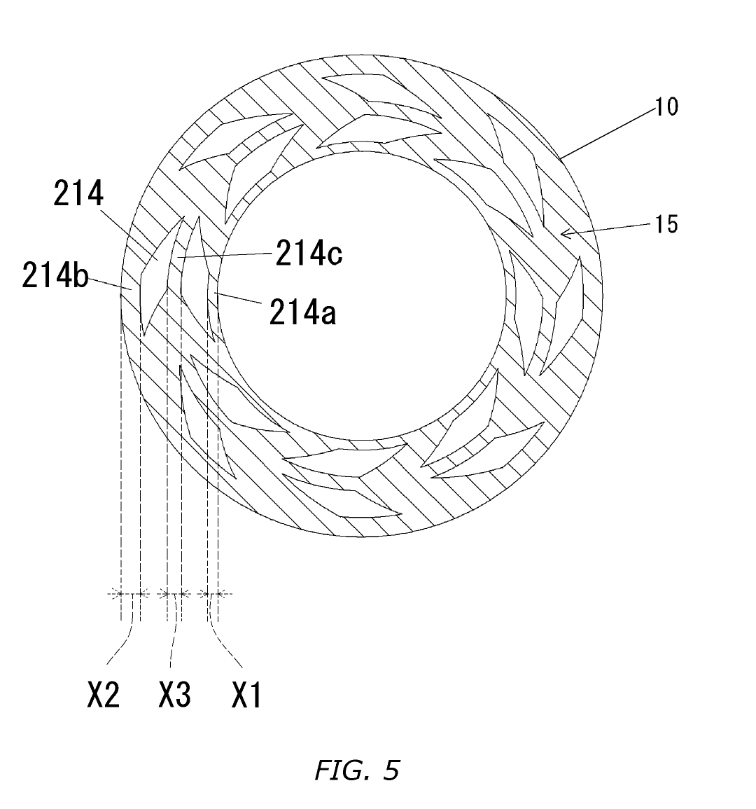

With reference to FIG. 5, the third preferred embodiment according to the present invention is described in detail.

As shown in FIG. 5, a thrust middle planar circumferential portion 214c is formed at a substantially middle portion of a bottom thrust dynamic bearing portion 215. A radial width X3 of the thrust middle planar circumferential portion 214c is wider than the radial width X1 of an inner planar circumferential portion 214a. The thrust middle planar circumferential portion 214c cooperates with an outer planar circumferential portion 211b and the inner planar circumferential portion 214a so as to securely support the rotor.

### FOURTH PREFERRED EMBODIMENT

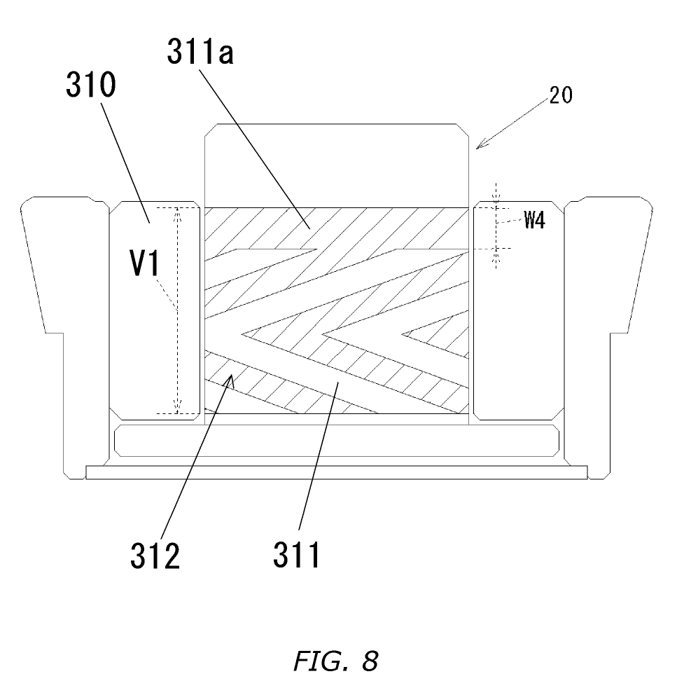

With reference to FIG. 8, a fourth preferred embodiment according to the present invention is described in detail.

A radial dynamic bearing portion 312 is formed at a gap between an inner circumferential surface of a shaft 310 and an outer circumferential surface of a shaft 320. The radial dynamic bearing portion 312 includes one radial portion at which the dynamic pressure of the lubricant fluid is maximized. Hereinafter, a radial gap V1 is defined as a gap between an outer circumferential surface of the shaft 320 and an inner circumferential surface of the sleeve 310 on which an upper planar circumferential portion and a bottom planar circumferential portion are provided.

An upper planar circumferential portion 311a is formed at an upper portion of a groove row 311 of the dynamic pressure generating grooves circumferentially arranged on an inner circumferential surface of the sleeve 310 so as to form a herringbone shape. The radial dynamic bearing portion 312 has the compositions similar to those described in the first preferred embodiment of the present invention.

An axial width W4 of the upper planar circumferential portion 311a is wider than the axial width W1 of the upper planar circumferential portion 11a of the first preferred embodiment.

In this preferred embodiment, the bottom planar circumferential portion is not provided at the gap V1 so as to provide an axially wider W4 of the upper planar circumferential portion 311a than the W1 of the first preferred embodiment. Therefore, the anti-slant property of the upper planar circumferential portion 311a is improved when the motor rotates, such that the rotor may be securely supported.

### FIFTH PREFERRED EMBODIMENT

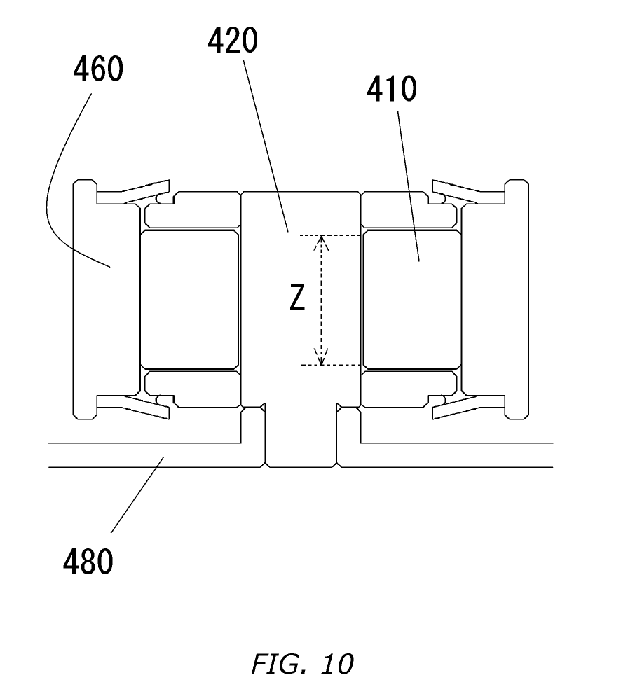

With reference to FIG. 10, the fifth preferred embodiment of the present invention is described in detail.

A shaft 420 is fixed to a center portion of a base 480, and an outer circumferential surface of the shaft 420 is inserted into a sleeve 410 which is in a substantially cylindrical shape and is a part of the rotor. A rotor hub having a disk placing portion (not shown in Figs) is fixed to the outer circumferential portion of the sleeve 410. Alternatively, the sleeve 410 and the rotor hub 460 may be integrally formed into a single member.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

For example, dynamic pressure generating grooves of groove row may be formed in axially symmetric shapes. As the rotor rotates, the movement pressures induces the oil from the axially upper and bottom end portions to the substantially middle portion of the radial dynamic bearing portion. Therefore, the pressure of the oil becomes maximum at the substantially middle portion of the radial dynamic bearing portion and supports the rotor during its rotation.

Alternatively, the fluid dynamic bearing may be so-called gas dynamic bearing adopting air as fluid. Moreover, the spindle motor according to the present invention may be used for the driving source of recording disk driving devices other than hard disk driving devices (such as removable disk driving devices).

What is claimed is:

1] A fluid dynamic bearing comprising:
a sleeve portion which is in a substantially cylindrical shape and has an inner circumferential surface;
a shaft which is inserted into the sleeve portion and is rotatable around a rotation axis relative to the sleeve portion, the shaft has an outer circumferential surface facing the inner circumferential surface of the sleeve portion;
a rotor which is fixed either to the sleeve portion or to the shaft, the rotor includes a disk placing portion arranged at an axially upper portion of the sleeve or of the shaft to place recording disks thereon;
a lubricant fluid retained in a radial gap between the inner circumferential surface of the sleeve portion and the outer circumferential surface of the shaft;
a radial dynamic bearing portion which is formed at the radial gap and includes only one groove row of the dynamic pressure generating grooves circumferentially arranged so as to form a herringbone shape inducing the dynamic pressure in the lubricant fluid during the rotation of the rotor; and
an upper planar circumferential portion formed at a position which locates upward from an upper end portion of the groove row, the position is either on the outer circumferential portion of the shaft or on the inner circumferential surface of the sleeve portion which compose the radial gap; wherein
the center of gravity of the rotor locates in a position which locates upward from a portion at which the dynamic pressure of the lubricant fluid is maximized during the rotation of the rotor.

2] A fluid dynamic bearing as set forth in claim 1, wherein a bottom planar circumferential portion is formed at a portion positioned lower from a bottom end of the groove row and is either on the outer circumferential surface of the shaft or on the inner circumferential surface of the sleeve portion which compose the radial gap.

3] A fluid dynamic bearing as set forth in claim 2, wherein axial width of the bottom planar circumferential portion is narrower than axial width of the upper planar circumferential portion.

4] A fluid dynamic bearing as set forth in claim 1, wherein:
each dynamic groove generating groove of the radial dynamic bearing portion includes a pair of spiral grooves inclining from the rotation axis and is formed by axially neighboring each spiral groove composing the pair of spiral grooves; and
a radially middle planar circumferential portion is formed at a portion where the spiral grooves are axially neighboring.

5] A fluid dynamic bearing as set forth in claim 4, wherein axial width of the radially middle planar circumferential portion is wider than axial width of the bottom planar circumferential portion.

6] A fluid dynamic bearing as set forth in claim 1, wherein:
a disk portion radially spreading from a bottom end portion of the shaft is formed at the bottom portion of the shaft;
a bottom thrust gap including the lubricant fluid therein is formed between an upper surface of the disk portion and a bottom surface of the sleeve portion axially facing the upper surface of the disk portion; and
a bottom thrust dynamic bearing portion which includes the groove row and induces the dynamic pressure on the lubricant fluid during the rotation of the rotor is formed either on the upper surface of the disk portion or on the bottom surface of the sleeve portion which compose the bottom thrust gap.

7] A fluid dynamic bearing as set forth in claim 6, wherein:
only one bottom thrust dynamic bearing portion is formed at the bottom thrust gap; and
an outer planar circumferential portion is formed at a position that is either on the upper surface of the disk portion or on the bottom surface of the sleeve portion which composes the bottom thrust gap, that is at a radially outward from the radially outer end of the groove row.

8] A fluid dynamic bearing as set forth in claim 6, wherein an inner planar circumferential portion is formed at a portion that is radially inward from a radially inner end of the groove row and is either on the upper surface of the disk portion or on the bottom surface of the sleeve portion which composes the bottom thrust gap.

9] A fluid dynamic bearing as set forth in claim 9, wherein radial width of the inner planar circumferential portion is narrower than radial width of the outer planar circumferential portion.

10] A fluid dynamic bearing as set forth in claim 6, wherein:
each dynamic groove generating groove of the bottom thrust dynamic bearing portion includes a pair of spiral grooves inclining from the rotation axis and is formed by axially neighboring each spiral groove composing the pair of spiral grooves; and
a thrust middle planar circumferential portion is formed at a portion where the spiral grooves axially neighbor.

11] A fluid dynamic bearing as set forth in claim 10, wherein radial width of the thrust middle planar circumferential portion is wider than radial width of the inner planar circumferential portion.

12] A fluid dynamic bearing as set forth in claim 6, wherein:
the rotor includes a bottom surface axially facing an upper end surface of the sleeve portion;
an upper thrust gap including the lubricant fluid therein is formed between the upper end surface of the sleeve portion and a bottom surface of the rotor; and
an upper thrust dynamic bearing portion which includes the groove row and induces the dynamic pressure on the lubricant fluid during the rotation of the rotor is formed either on the bottom surface of the rotor or on the upper end surface of the sleeve portion which compose the upper thrust gap.

13] A fluid dynamic bearing as set forth in claim 1, wherein:
the rotor includes a bottom surface axially facing an upper end surface of the sleeve portion;
an upper thrust gap including the lubricant fluid therein is formed between the upper end surface of the sleeve portion and a bottom surface of rotor; and
an upper thrust dynamic bearing portion which includes the groove row and induces the dynamic pressure on the lubricant fluid during the rotation of the rotor is formed either on the bottom surface of the rotor or on the upper end surface of the sleeve portion which composes the upper thrust gap.

14] A fluid dynamic bearing as set forth in claim 1, wherein the sleeve portion includes a sleeve which composes the radial gap and is made of oil-containing porous material, a sleeve housing which supports the sleeve from an outer circumferential side thereof, and a plate which occludes the sleeve housing and the sleeve from a bottom side.

15] A fluid dynamic bearing as set forth in claim 1, wherein:
each dynamic groove generating groove of the radial dynamic bearing portion includes a pair of spiral grooves inclining from the rotation axis and is formed by axially neighboring each spiral groove composing the pair of spiral grooves; and
axial width of an upper spiral groove is wider than axial width of a bottom spiral groove.

16] A fluid dynamic bearing as set forth in claim 1, wherein axial length of the radial gap is about less than 2.3 millimeters.

17] A spindle motor comprising:
a rotor magnet supported by the rotor;
the fluid dynamic bearing as set forth in claim 1; and
a stator radially facing the rotor magnet with a gap maintained therebetween.

18] A recording disk driving device to which a recording disk is loaded, comprising:
a housing;
the spindle motor as set forth in claim 17 which rotates the recording disk fixed within the housing; and
an accessing portion which read or write the information from or on a specific location of the recording disk.

19] A fluid dynamic bearing comprising:
a sleeve portion which is in a substantially cylindrical shape and has an inner circumferential surface;
a shaft which is inserted into the sleeve portion and is rotatable around a rotation axis relative to the sleeve portion, the shaft has an outer circumferential surface facing the inner circumferential surface of the sleeve portion;
a rotor which is fixed either to the sleeve portion or to the shaft, the rotor includes a disk placing portion arranged at an axially upper portion of the sleeve or of the shaft to place recording disks thereon;
a lubricant fluid retained in a radial gap between the inner circumferential surface of the sleeve portion and the outer circumferential surface of the shaft;
a radial dynamic bearing portion which is formed at the radial gap and includes only one groove row of the dynamic pressure generating grooves circumferentially arranged so as to form a herringbone shape inducing the dynamic pressure in the lubricant fluid during the rotation of the rotor;
an upper planar circumferential portion formed at a position which locates upward of an upper end portion of the groove row, the position is either on the outer circumferential portion of the shaft or on the inner circumferential surface of the sleeve portion which compose the radial gap; and
a bottom planar circumferential portion formed at a position which locates downward from the bottom end portion of the groove row, the portion is either on the outer circumferential portion of the shaft or on the inner circumferential surface of the sleeve portion which compose the radial gap; wherein the center of gravity of the rotor locates in a position which locates upward from a portion at which the dynamic pressure of the lubricant fluid is maximized during the rotation of the rotor.

20] A fluid dynamic bearing as set forth in claim 19, wherein axial width of the upper planar circumferential portion is wider than axial width of the bottom planar circumferential portion.
